(19) United States
(12) Patent Application Publication
(10) Pub. No.: US 2023/0007420 A1
(43) Pub. Date: Jan. 5, 2023

(54) ACOUSTIC MEASUREMENT

(71) Applicant: University of York, York, North Yorkshire (GB)

(72) Inventors: Gavin Kearney, York, Yorkshire (GB); Calum Armstrong, Yorshire (US)

(21) Appl. No.: 17/757,063

(22) PCT Filed: Nov. 27, 2020
(86) PCT No.: PCT/GB2020/053043

§ 371 Date: Jun. 8, 2022

(30) Foreign Application Priority Data
Dec. 9, 2019 (GB) 1918010.8

(51) Int. Cl. H04S 7/00

(52) U.S. Cl. CPC H04S 7/30; H04S 2420/01

(57) ABSTRACT

A method for determining subject specific digital audio data can comprise providing at least one respective audio signal input to each of a plurality of loudspeaker elements supported in a predetermined spatial relationship, in which respective locations of an effective point source of each loudspeaker element all lie in an imaginary surface that at least partially contains a spatial region where at least one aural cavity of a subject is located, thereby providing a distance between each respective location and each aural cavity of less than 1.5 meters. Responsive to at least one audio signal output from at least one of the loudspeaker elements, via at least one microphone element located at or within an aural cavity of the subject, respective subject specific audio data output is provided and is processed via an audio processing system, the subject specific audio data output, thereby providing subject specific digital audio data.

The present invention relates to a method and apparatus for providing subject specific digital audio data and a subject specific digital audio profile. In particular, but not exclusively, the present invention relates to the near-field acoustic measurement of Head Related Transfer-Functions (HRTFs) of a subject (e.g. a person, a dummy mannequin, or an anthropomorphic model) to provide a binaural Ambisonics profile for that subject.

It can be said that the physical characteristics of a person affect how they perceive sound. Example physical characteristics include, but at are not limited to, the size, shape, and composition of the person's torso, head, facial features, and ears. Consequently, when creating or recreating an audio experience for a person, one may wish to account for their physical characteristics to make the experience more immersive and realistic for that person.

HRTFs quantify the cumulative effect of such physical characteristics on the perception of sound incoming from a given point in space relative to a listener across a band of frequencies. By convolving an audio signal with an HRTF, an audio signal can be transformed to behave as though it has been modified by a person's relevant physical characteristics. For example, after an appropriate mathematical operation involving an HRTF, or a set of HRTFs, associated with the same given point, a sound can be transformed to a form that, if played back over a pair of earphones or headphones, would sound to a listener as though the origin of the sound was that given point.

One subject area in which HRTFs are utilised is the field of binaural audio. Binaural audio involves simulating a three-dimensional soundfield directly at the ears of a listener.

The HRTFs used in research and industry are what is may be referred to as ‘non-individual’, i.e. they are HRTFs determined from a dummy mannequin or anthropomorphic model constructed to represent some average of the relevant physical characteristics of a population. This one-size-fits-all approach can lead to an unsatisfactory audio experience for a listener and is often unsuitable for applications where a high degree of immersion and/or accuracy of sound localisation is required.

‘Personal’ or ‘individual’ HRTFs can be determined from the output data of a microphone, located on or within the ear of a person, responsive to impulses of given frequencies, or a signal representative thereof, transmitted by a loudspeaker element at a predetermined location. Creation of such personal HRTFs conventionally require loudspeaker arrays supported over a considerable distance from a subject. This makes it costly to provide and inconvenient for a user/subject to access.

Despite the disadvantages of non-individual HRTFs, they remain in use at least in part due to the above-mentioned impracticalities and cost-prohibitive nature of existing solutions for providing HRTF acoustic measurements of an individual. For example, these existing solutions for providing subject specific HRTFs require a large (and expensive) loudspeaker array and the measurement process is uncomfortable for the individual being measured. One reason that a large loudspeaker array is used to take acoustic measurements of an individual is due to the complications that arise when trying to measure HRTFs in the near-field as a result of the effects of distance on the properties of a propagating sound wave.

It is an aim of the present invention to at least partly mitigate one or more of the above-mentioned problems.

It is an aim of certain embodiments of the present invention to provide apparatus and a method for taking HRTF near-field acoustic measurements of a specific subject and for providing subject specific audio data.

It is an aim of certain embodiments of the present invention to provide apparatus and a method for taking HRTF near-field acoustic measurements of a specific subject with greater proximity to the subject than conventional solutions allow.

It is an aim of certain embodiments of the present invention to provide apparatus for taking HRTF acoustic measurements of a subject that is cheaper and more convenient to transport and construct and of a smaller physical footprint than conventional solutions allow.

It is an aim of certain embodiments of the present invention to provide apparatus and a method for providing a subject specific binaural Ambisonic renderer determined from acoustic measurements taken in a near-field regime.

It is an aim of certain embodiments of the present invention to provide apparatus and a method for providing a personal binaural Ambisonic renderer determined from acoustic measurements taken in a near-field regime.

It is an aim of certain embodiments of the present invention to provide apparatus and a method for providing a binaural Ambisonic renderer determined from acoustic measurements of a subject taken in a near-field regime.

It is an aim of certain embodiments of the present invention to provide apparatus and a method for providing HRTFs exhibiting the distance-related characteristics of far-field HRTF data from near-field HRTF data.

It is an aim of certain embodiments of the present invention to provide apparatus and a method for providing HRTFs.

It is an aim of certain embodiment of the present invention to provide a subject audio data profile determined from acoustic measurements taken in the near field regime.

It is an aim of certain embodiment of the present invention to provide a personal audio data profile determined from acoustic measurements taken in the near field regime.

It is an aim of certain embodiment of the present invention to provide a subject audio data profile for enabling more immersive and realistic binaural audio experiences.

According to a first aspect of the present invention there is provided apparatus for providing subject specific digital audio data, comprising:
a plurality of loudspeaker elements, each responsive to at least one respective audio signal input and supported in a predetermined spatial relationship in which respective locations of an effective point source of each loudspeaker element all lie in an imaginary surface that at least partially contains a spatial region where a subject comprising at least one aural cavity is locatable;
at least one microphone element locatable on or within an aural cavity of the subject, for providing a respective subject specific audio data output responsive to at least one physical characteristic of the subject and an audio signal output from at least one of the loudspeaker elements; and
an audio processing element for processing the subject specific audio data output and providing subject specific digital audio data for said subject, responsive thereto; wherein
a distance between each respective location and each aural cavity is less than 1.5 metres.

Aptly the subject specific digital audio data comprises data that represents a superposition of sound, from the plurality of effective point sources of the loudspeaker elements, at the aural cavity responsive to at least one physical characteristic of the subject.

Aptly each subject specific audio data output comprises a digital or analogue representation of a physical reverberation of an active element of the respective microphone element responsive to a superposition of sound, including sound from the plurality of effective point sources of the loudspeaker elements, at the active element.

Aptly said a distance is selected to provide a wave front of sound from any one of the loudspeaker elements, at each aural cavity, that is not effectively planar.

Aptly said a distance is selected to provide a near field sound wave provided by a superposition of sound, including sound from the plurality of effective point sources of the loudspeaker elements, at each aural cavity.

Aptly the superposition of sound from the loudspeaker elements at each aural cavity is sufficiently complex that subsequent processing of the subject specific audio data output requires at least one Ambisonic processing step.

Aptly each aural cavity of a subject comprises a sound receiving orifice opening into a channel; and supporting flesh or flesh imitating material surrounding the orifice and the channel.

Aptly each subject comprises at least one physical characteristic responsive to a shape and size of the orifice and the channel and/or a density, surface texture and/or layering of the supporting flesh or flesh imitating material.

Aptly the imaginary surface comprises a hemisphere or a portion of a hemisphere or a cylinder or a portion of a cylinder or a combined surface that includes a full or partial hemisphere portion and a full or partial cylindrical portion.

Aptly the subject is a person, or a dummy mannequin, or an anthropomorphic model.

Aptly the apparatus further comprises an alignment system for aligning the subject with respect to a predetermined location determined by the predetermined spatial relationship.

Aptly the alignment system comprises at least one visual display.

Aptly the alignment system comprises at least one video camera device.

Aptly the alignment system comprises at least one laser.

Aptly the visual display is responsive to at least one video camera device and/or at least one laser.

Aptly a position of at least one of the plurality of loudspeaker elements is adjustable responsive to a determined height of the subject.

Aptly the apparatus further comprises at least one linear actuator for adjusting a position of at least one of the plurality of loudspeaker elements responsive to a determined height of the subject.

Aptly the apparatus further comprises at least one panel or body of sound-dampening material proximate to the support.

Aptly at least a first group of the loudspeaker elements is connected to a further group of the loudspeaker elements via a hinged connection that allows the first group to be selectively located with respect to the further group.

Aptly the plurality of loudspeaker elements is free-standing.

Aptly the loudspeaker elements are supported via a support and the support comprises a modular rig.

Aptly the loudspeaker elements are supported via a support and the support is portable.

Aptly each said respective audio signal input is representative of an impulsive input.

Aptly the subject specific digital audio data comprises an analogue-to-digital conversion of a respective subject specific analogue audio data output.

Aptly the subject specific digital audio data comprises binaural subject specific digital audio data.

Aptly the subject specific digital audio data comprises data representative of at least one Head Related Transfer Function (HRTF).

Aptly the processed subject specific audio data comprises data representative of at least one near-field Head Related Transfer Function (HRTF).

Aptly the processed subject audio data comprises data representative of at least one near-field compensated (NFC) Head Related Transfer Function (HRTF).

Aptly the subject specific digital audio data comprises data representative of at least one synthesised far-field Head Related Transfer Function (HRTF).

Aptly the subject specific digital audio data comprises a binaural Ambisonic renderer.

Aptly the binaural Ambisonic renderer is a personal binaural Ambisonic renderer.

Aptly the apparatus further comprises a control interface for receiving user input.

Aptly the predetermined spatial relationship is a spatial relationship predetermined from a regular 2-dimensional shape or a regular 3-dimensional shape.

Aptly the predetermined spatial relationship is determined from a Lebedev grid distribution.

According to a second aspect of the present invention there is provided a method for determining subject specific digital audio data, comprising:
providing at least one respective audio signal input to each of a plurality of loudspeaker elements supported in a predetermined spatial relationship, in which respective locations of an effective point source of each loudspeaker element all lie in an imaginary surface that at least partially contains a spatial region where at least one aural cavity of a subject is located, thereby providing a distance between each respective location and each aural cavity of less than 1.5 metres:
responsive to at least one audio signal output from at least one of the loudspeaker elements, via at least one microphone element located at or within an aural cavity of the subject, providing respective subject specific audio data output; and
via an audio processing system, processing the subject specific audio data output, thereby providing subject specific digital audio data.

Aptly the method further comprises providing the subject specific digital audio data as data that represents a superposition of sound at the aural cavity responsive to at least one physical characteristic of the subject.

Aptly the method further comprises providing the subject specific audio data output as a digital or analogue representation of a physical reverberation of an active element of a respective microphone element responsive to a superposition of sound at the active element.

Aptly the method further comprises locating a subject that comprises a person or a dummy mannequin or an anthropomorphic model in a spatial region that is at least partially contained by an imaginary surface in which an effective point source of each loudspeaker element lies.

Aptly the method further comprises prior to or subsequent to locating the subject in the spatial region, adjusting a height of at least one loudspeaker element with respect to a floor surface via which the subject is located.

Aptly the method further comprises providing to each loudspeaker element as an impulse signal or a signal representative of an impulse, respective audio signal inputs.

Aptly the method further comprises converting the subject specific audio data output via an analogue-digital conversion step thereby providing the subject specific digital audio data.

Aptly the method further comprises providing at least one near field compensated (NFC) Head Related Transfer Function (HRTF) via application of a near field compensation audio processing step to the subject specific audio data output.

Aptly the method further comprises modifying at least one NFC HRTF and providing at least one synthesised far-field HRTF.

Aptly the method further comprises formatting a suitable collection of HRTFs and providing a subject specific binaural Ambisonic renderer.

Aptly the predetermined spatial relationship is a spatial relationship predetermined from a regular 2-dimensional shape or a regular 3-dimensional shape.

Aptly the predetermined spatial relationship is determined from a Lebedev grid distribution.

According to a third aspect of the present invention there is provided a subject specific digital audio profile, determined from at least one analogue audio data output provided by at least one microphone element located on or within at least one aural cavity of a subject, that comprises a subject specific Ambisonics renderer that modifies digital audio input data according to at least one physical characteristic of a subject and provides personalised audio data output responsive thereto, wherein:
the at least one microphone element is responsive to an audio signal output of at least one of a plurality of loudspeaker elements that are supported in a predetermined spatial relationship in which respective locations of an effective point source of each loudspeaker element all lie in an imaginary surface that at least partially contains a spatial region where a subject comprising at least one aural cavity is locatable, wherein a distance between each respective location and each aural cavity is less than 1.5 metres; and
the analogue audio data output is processed via a near-field compensation audio processing technique.

Aptly the subject is a person, or a dummy mannequin, or an anthropomorphic model.

Aptly each said respective audio signal input is representative of an impulsive input.

Aptly the subject digital audio data comprises an analogue-to-digital conversion of the respective subject analogue audio data.

Aptly the subject audio data comprises binaural subject digital audio data.

Aptly the subject digital audio data comprises data representative of at least one Head Related Transfer Function (HRTF).

Aptly the subject digital audio data comprises data representative of at least one near-field Head Related Transfer Function (HRTF).

Aptly the subject digital audio data comprises data representative of at least one near-field compensated (NFC) Head Related Transfer Function (HRTF).

Aptly the subject digital audio data comprises at least one synthesised far-field Head Related Transfer Function (HRTF).

Aptly the predetermined spatial relationship is a spatial relationship predetermined from a regular 2-dimensional shape or a regular 3-dimensional shape.

Aptly the predetermined spatial relationship is determined from a Lebedev grid distribution.

Certain embodiments of the present invention provide acoustic measurements of a subject and subject digital audio data at a lower cost and/or with greater convenience than existing solutions.

Certain embodiments of the present invention provide apparatus, for providing acoustic measurements of a subject and subject audio data, that occupies a reduced footprint and/or physical space than existing solutions.

Certain embodiments of the present invention provide a method that provides subject digital audio data determined from acoustic measurements of a subject taken within greater proximity to the subject than existing solutions.

Certain embodiments of the present invention provide HRTF data exhibiting the distance-related characteristics of far-field HRTF data from near-field HRTF data.

Certain embodiments of the present invention provide a subject specific digital audio profile for enabling more immersive and realistic binaural audio experiences.

Certain embodiments of the present invention provide a personal digital audio profile for enabling more immersive and realistic binaural audio experiences.

Certain embodiments of the present invention provide a personal audio filter that affects the sound localisation characteristics of a sound according to the physical characteristics of a person.

Certain embodiments of the present invention provide a subject specific audio filter that affects the sound localisation characteristics of a sound according to the physical characteristics of the subject.

Certain embodiments of the present invention provide a loudspeaker array arranged according to a regular or approximately regular grid distribution that is height-adjustable located proximate to a subject.

Embodiments of the present invention will now be described hereinafter, by way of example only, with reference to the accompanying drawings in which:

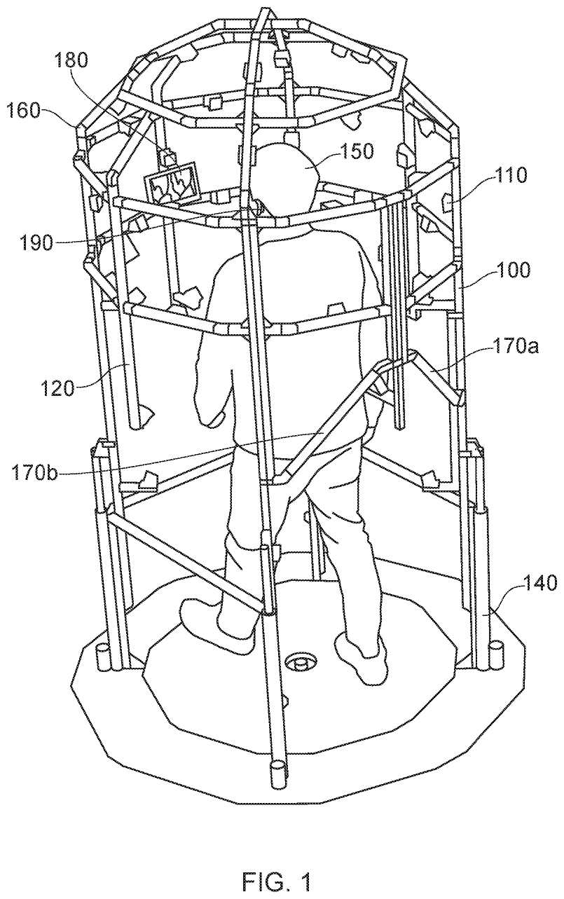

FIG. 1 illustrates an acoustic measurement chamber;

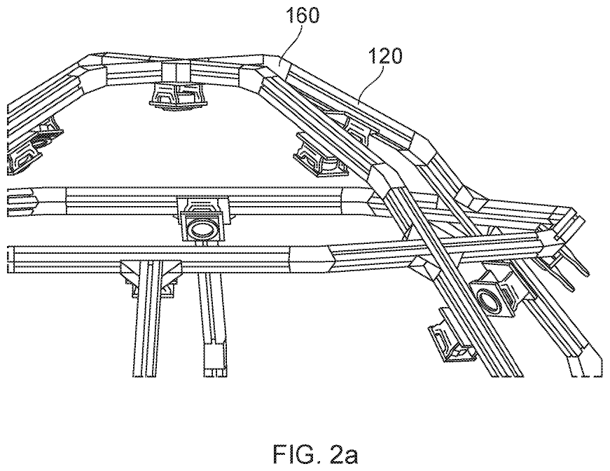

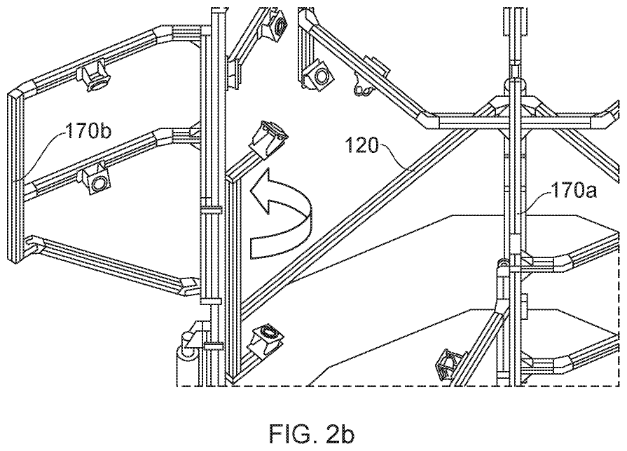

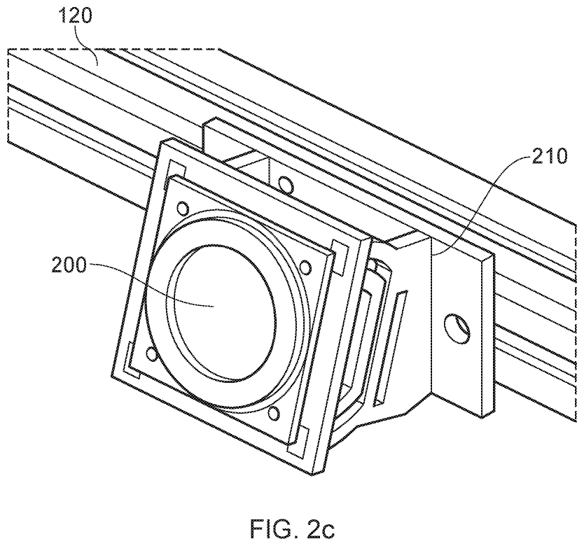

FIG. 2a illustrates an alternative view of part of an acoustic measurement chamber;

FIG. 2b illustrates an alternative view of part of an acoustic measurement chamber;

FIG. 2c illustrates a view of a loudspeaker;

FIG. 2d illustrates a view of a loudspeaker;

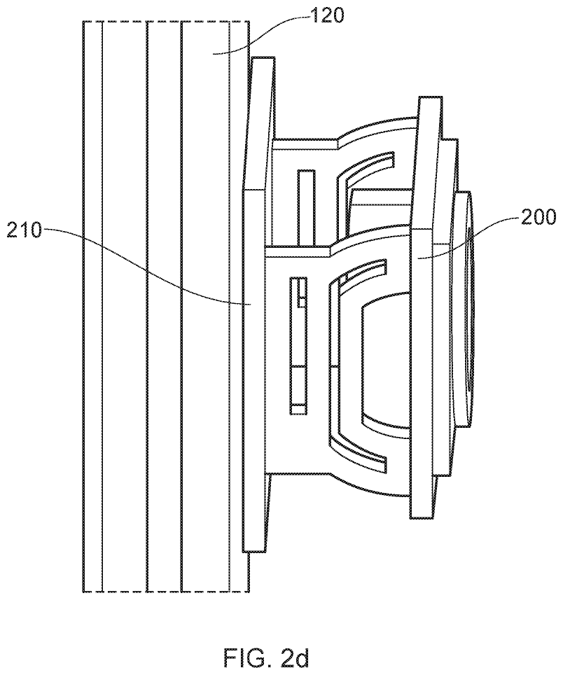

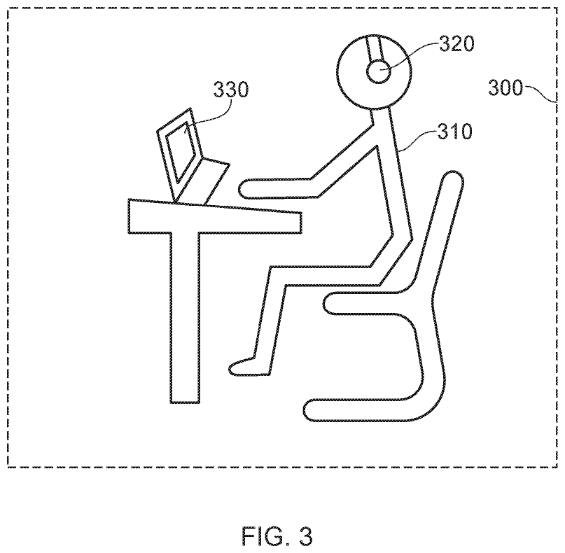

FIG. 3 illustrates a content consumer consuming binaural Ambisonic content;

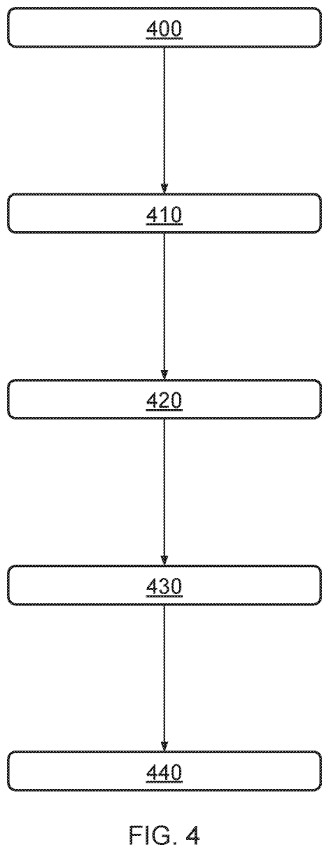

FIG. 4 illustrates the steps to take acoustic measurements of a subject;

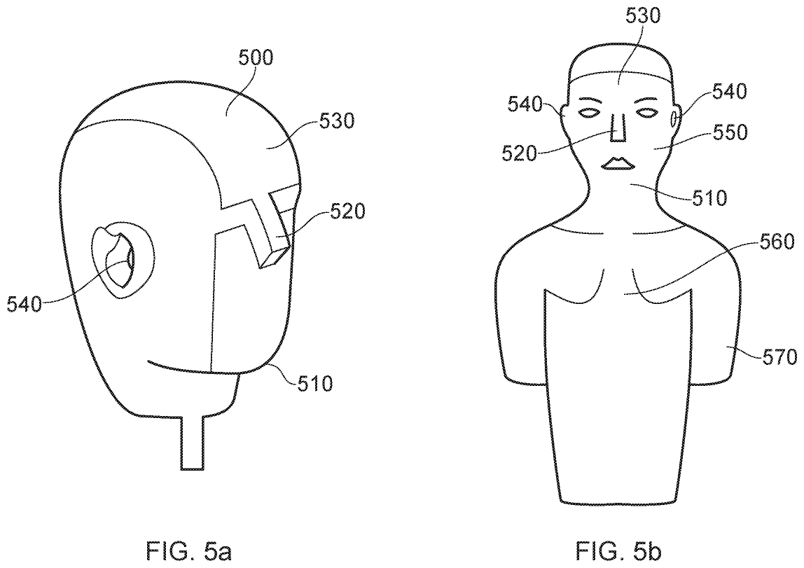

FIG. 5a illustrates an anthropomorphic model;

FIG. 5b illustrates a dummy mannequin;

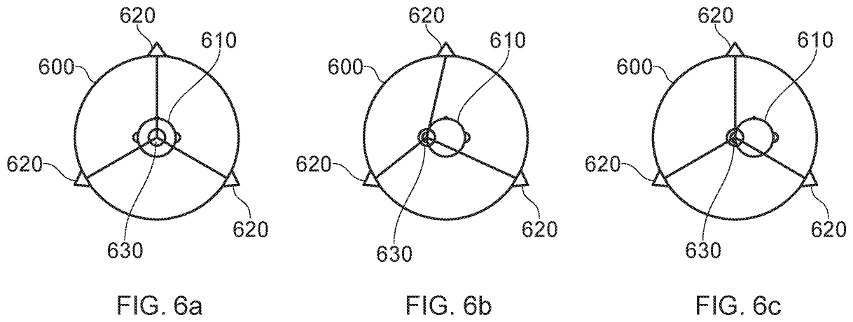

FIG. 6a illustrates a sweet spot of binaural audio reproduction;

FIG. 6b illustrates a further sweet spot of binaural audio reproduction;

FIG. 6c illustrates a further sweet spot of binaural audio reproduction;

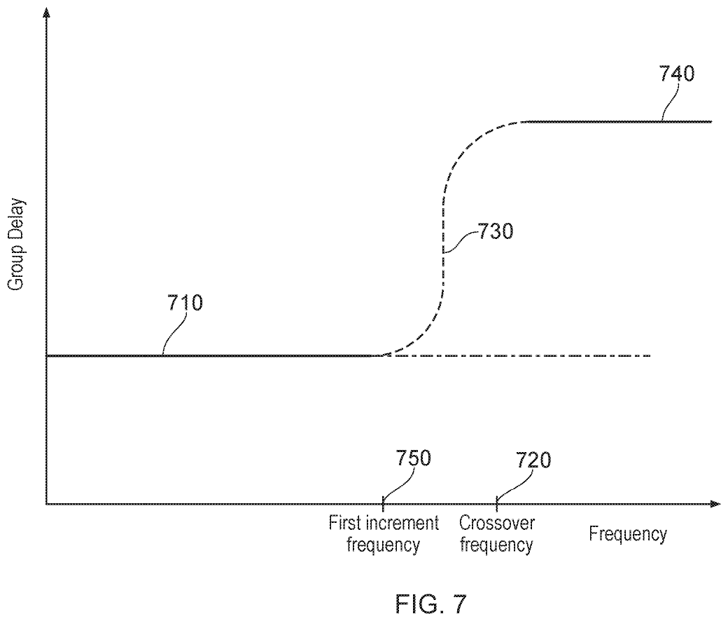

FIG. 7 illustrates the group delay against frequency of an audio signal;

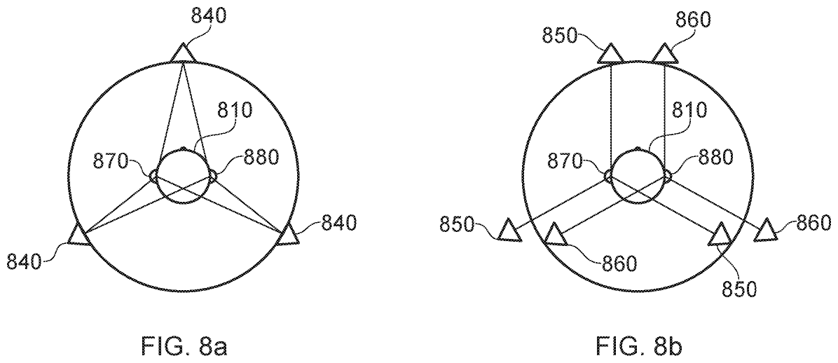

FIG. 8a illustrates a virtual loudspeaker array for head-centred Ambisonic decoding;

FIG. 8b illustrates a virtual loudspeaker array for BiRADIAL Ambisonic decoding;

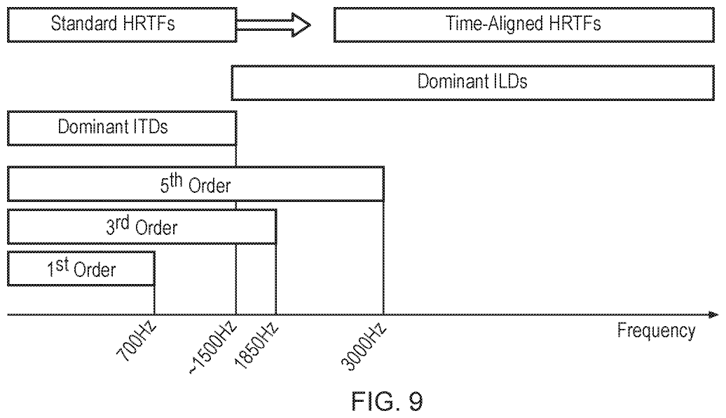

FIG. 9 illustrates the frequencies at which different Ambisonic and HRTFs can be used;

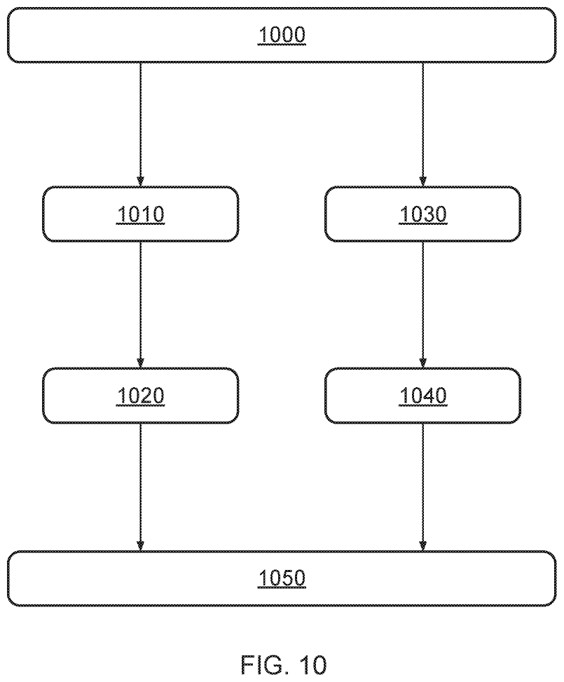

FIG. 10 illustrates the steps of a method to determine a near-field time-aligned HRTF;

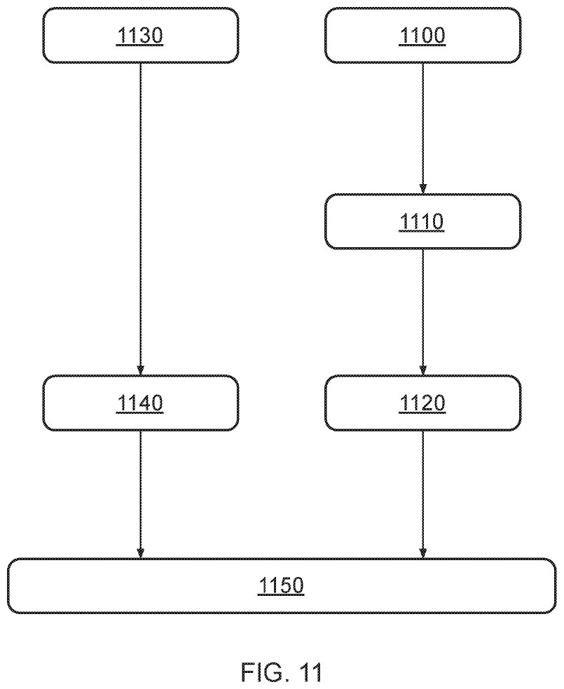

FIG. 11 illustrates the steps of a method to determine a near-field hybrid HRTF;

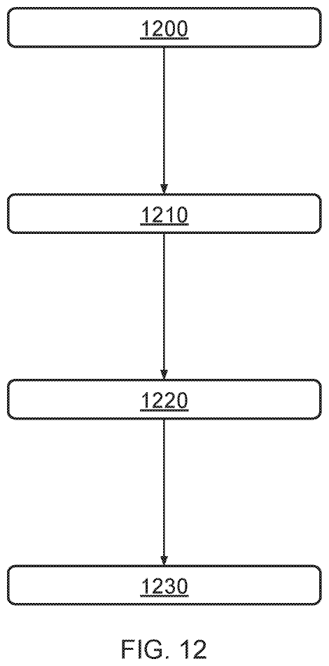

FIG. 12 illustrates the steps of a method to determine a synthesised far-field HRTF;

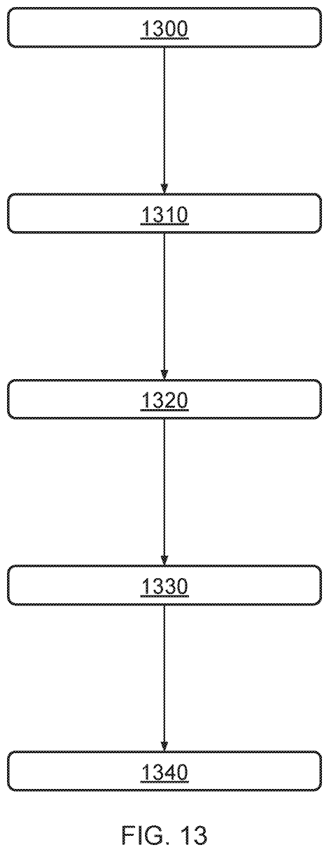

FIG. 13 illustrates the steps of a method to provide a subject specific binaural Ambisonic renderer; and

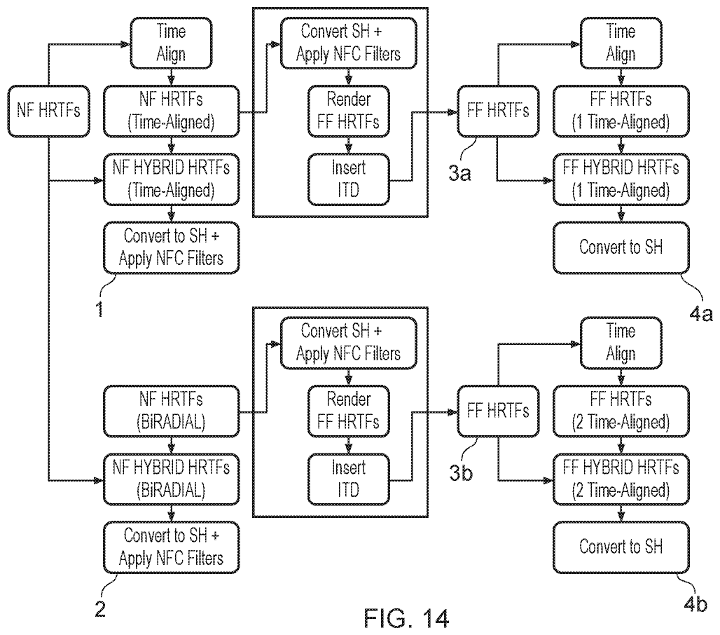

FIG. 14 illustrates a combined workflow.

In the drawings like reference numerals refer to like parts.

FIG. 1 illustrates an acoustic chamber 100. The acoustic chamber 100 comprises a support structure 120 constructed from beams connected via brackets 160. Optionally, the support structure 120 and the brackets 160 comprise a modular rig. Optionally, the modular rig is portable. The loudspeakers 110 are mounted to the support structure 120 according to a predetermined spatial relationship. This can approximate the positions the loudspeakers 110 would have relative to each other if the loudspeakers 110 were proximate to equally angularly distributed respective points on the surface of a Platonic solid (i.e. a cube, an octahedron, etc). In other words, the loudspeakers 110 can be arranged on the support structure such that each loudspeaker 110 corresponds to a point on an imaginary, regular three-dimensional solid, where the angular distribution of the points is approximately constant. By arranging the loudspeakers 110 in this way, the signals transmitted by each loudspeaker 110 will superpose at particular points in space producing ‘sweet spots’ within the acoustic chamber 100 relative to a person 150 aligned at a reference point in the acoustic chamber 100, increasing the quality of the acoustic measurements. Alternatively, the loudspeakers 110 can be arranged on the support structure 120 according to a Lebedev grid distribution. Optionally, the loudspeakers 110 can be arranged on the support structure 120 according to a regular two-dimensional polygon (i.e. a square, pentagon, etc).

Linear actuators 140 can adjust the height of the support structure 120 suitable for a person 150 to stand (or, if appropriate, sit) inside the acoustic chamber 100. A first portion 170a and second portion 170b of the support structure 120 are each connected to the remainder of the support structure 120 via hinges, allowing the first and second portions 170a, 170b to swing outwards, suitable for a person 150 to walk into the acoustic chamber 100.

A display 180 comprises a part of a self-alignment system that gives feedback to the person 150 so that the person 150 can align himself at a predetermined reference point in the acoustic chamber 100. The self-alignment system further comprises at least one video camera that provides a video feed to the display 180 that can be overlaid with visual instructions on the display 180 that tell the person 150 how to adjust themselves within the chamber. Optionally, the self-alignment system further comprises at least one laser which measures the distance of a respective location of the person 150 from the laser.

At least one ear 190 of the person 150 is located within the acoustic chamber 100. Depending on the particular set of acoustic measurements that are desired, the combination of the signals transmitted by the loudspeakers 110 can generate a sweet spot centred in proximity to the centre of the head of the person 150, a sweet spot centred in proximity to the orifice of one ear 190, or two sweet spots each centred respectively in proximity to the opening of each of two ears of the person 150. Ear-locatable microphones are located on or within at least one ear 190. The ear-locatable microphones record sound transmitted by the loudspeakers 110 after the sound has been affected (e.g. via reflection, diffraction, and refraction) by the physical characteristics of the person 150. Example physical characteristics include the size, shape, and composition of the body, torso, head, facial features, and ears of the person 150. Optionally, ‘composition’ may refer to the density and/or surface texture and/or layering of flesh or flesh imitating material. The acoustic chamber 100 is of a size such that when the person 150 is aligned at the centre of the acoustic chamber 100, the loudspeakers 110 mounted to that support structure 120 are at sufficiently close distance to the person 150 such that the wave fronts of sound waves transmitted by the loudspeakers 110 are effectively non-planar. Such a distance may be referred to as ‘near field’. In the ‘near field’ of a subject, small changes in the distance of the subject to a source are perceptually relevant. Aptly, the near-field represents a region of space close to the head of a subject/listener such that the wave front curvature of a sound wave are perceptually significant.

It will be understood that instead of a person 150, a dummy mannequin or anthropomorphic model can be located in the acoustic chamber 100 and microphones can be located on or within at least one artificial ear/aural cavity. An ear or an artificial ear is an example of an aural cavity.

It will be understood that the acoustic chamber 100 shown in FIG. 1 is an upstanding chamber. It will also be understood that a horizontal chamber could also be provided to obtain acoustic measurements in accordance with the present invention. A horizontal acoustic chamber might be an acoustic chamber where a subject is measured in a prone or supine position. A horizontal chamber might also be ‘height’ adjustable. In this context a ‘height’ of the horizontal acoustic chamber refers to the length of the chamber extending along the prone or supine subject from head to toe, or from head to base, from or top to bottom, etc.

It will be understood that the acoustic chamber 100 has an associated imaginary surface that the size and shape of the support structure 120 resembles. For example, the acoustic chamber as illustrated in FIG. 1 has an associated imaginary surface comprising a hemispherical top connected to a cylindrical or tube-like body extending to the floor.

In FIG. 1, the acoustic chamber 100 surrounds the person 150. It will be understood that a partial acoustic chamber can also be used to take acoustic measurements. A partial acoustic chamber may have an associated imaginary surface, which at least partially contains the person 150, for example comprising a hemispherical top connected to a semi-cylindrical body or a semi-hemispherical (i.e. a quarter sphere) top connected to a cylindrical body.

It will be understood that sound-dampening material, such as acoustic foam, can be mounted to the outside of the acoustic chamber 100 and/or between the beams of the support structure 120 and/or positioned externally to at least partially surround the acoustic chamber 100. By mounting acoustic foam to, or in proximity to, the acoustic chamber 100, external noise can be reduced increasing the quality of acoustic measurements determined using the acoustic chamber 100.

FIG. 2a illustrates a top portion of the acoustic chamber 100. It will be understood that the top portion has an associated imaginary surface for example a hemisphere or a semi-hemisphere. Loudspeakers could be supported in a way that creates an imaginary surface that is a partial hemisphere and/or a partial cylinder.

FIG. 2b illustrates a first portion 170a of the support structure 120 in an open position and a second portion 170b of the support structure 120 in a closed position. An open position refers to a position where a first or a second portion of the support structure 120 is rotated, for example on a hinge connected to the remainder of the support structure 120, relative to the remainder of the support structure 120 such that when both a first portion and a second portion of the support structure 120 are in an open position, the acoustic chamber 100 is suitable for a person to walk in and stand or sit within the acoustic chamber 100 (up to any height-adjustment).

FIG. 2c illustrates a loudspeaker driver 200 of a loudspeaker 110 mounted via a mounting bracket 210 to a beam of the support structure 120. The loudspeaker driver 200 is an active element and is the component of the loudspeaker 110 that vibrates responsive to an audio signal input to the loudspeaker 110 to generate sound. A collection of the loudspeakers 200 can be referred to as a ‘loudspeaker array’. A collection of loudspeakers can be used to create one or more ‘virtual loudspeaker array(s)’. A virtual loudspeaker array can be created via the appropriate interference of sound waves transmitted by a collection of loudspeakers such that the resulting sound provides to an appropriately located listener the illusion of sources of sound that do not physically exist. Such illusory sources may be referred to as ‘virtual sources’ or ‘effective sources’. Optionally, a loudspeaker array can be used to create two virtual loudspeaker arrays, one for each ear 190 of a person 150, wherein each virtual loudspeaker array comprises virtual loudspeakers located at an equal distance from the respective ear the person 150. Optionally, a loudspeaker array can be used to create a virtual loudspeaker array comprising virtual loudspeakers located at an equal distance from the ear 190 of the person 150. Optionally, a loudspeaker array can be used to create a virtual loudspeaker array comprising virtual loudspeakers located at an equal distance from the centre of the head of a person 150.

FIG. 2d illustrates a side view of a loudspeaker driver 200 of a loudspeaker 110 mounted via a mounting bracket 210 to a beam of the support structure 120.

Aptly, the acoustic chamber 100 provides apparatus for providing subject specific digital audio data. The acoustic chamber includes a plurality of loudspeaker elements 200, each of these is responsive to at least one respective audio signal input and is supported in a predetermined spatial relationship in which respective locations of an effective point source of each loudspeaker element 200 all lie in an imaginary surface that at least partially contains a spatial region where a subject 150 comprising at least one aural cavity 190 is locatable. At least one microphone element is locatable on or within an aural cavity 190 of the subject 150, for providing a respective subject specific audio data output responsive to at least one physical characteristic of the subject and an audio signal output from at least one of the loudspeaker elements 200. An audio processing element can be included for processing the subject specific audio data output and providing subject specific digital audio data for said subject 150, responsive thereto. A distance between each respective location and each aural cavity 190 is less than about 1.5 metres.

Aptly, a distance between each respective location and each aural cavity 190 is about 1.5 metres. Aptly, a distance between each respective location and each aural cavity 190 is less than about 1.45 metres; or less than about 1.4 metres; or less than about 1.35 metres; or less than about 1.3 metres; or less than about 1.25 metres; or less than about 1.2 metres; or less than about 1.15 metres; or less than about 1.1 metres; or less than about 1.05 metres; or less than about 1 metre; or less than about 0.95 metres; or less than about 0.9 metres; or is any value selected from these ranges; or any sub-range constructed from the values contained within any of these ranges. Aptly, each respective location is within the near-field of each aural cavity 190. Aptly, at least one respective location is within the near-field of each aural cavity 190. Aptly, at least two, three, four, five, six, seven, eight, nine, ten, eleven, twelve, thirteen, fourteen, fifteen, or sixteen respective locations are within the near-field of each aural cavity 190. Aptly, the acoustic chamber is adjustable to a height of 2 metres. Aptly the acoustic chamber is adjustable to a height of less than 2 metres. Aptly, the acoustic chamber is adjustable to a height of up to 2 metres. Aptly, the acoustic chamber is adjustable to height of, or above, 1 metre. Aptly, the acoustic chamber is adjustable to a height up to 1.5 metres; or up to 1.55 metres; or up to 1.6 metres; or up to 1.65 metres; or up to 1.7 metres; or up to 1.75 metres; or up to 1.8 metres; or up to 1.85 metres; or up to 1.9 metres; or up to 1.95 metres.

FIG. 3 illustrates a scene 300 wherein a person 310 is listening to audio content on a computer 330 via a pair of headphones 320. The audio content may a piece of music; a video (e.g. a film, a television programme, or an internet video); a computer game; or form a part of the production thereof. The headphones 320 may be on-ear or over-ear, or instead be in-ear earphones. The headphones 320 (or earphones) may be wired or wireless. The computer 330 may be a smartphone, a tablet, a laptop computer, a desktop computer, a music player, a server, a workstation, a pair of smart glasses, a Virtual Reality (VR) headset, or an augmented reality (AR) headset. A subject specific digital audio profile is stored in a memory unit, comprising part of either the computer 330 or the pair of headphones 320, or at a location remote from the user (for example a cloud server) relating to the audio content being consumed. A memory unit is a computing device capable of storing digital data in a volatile or non-volatile form.

FIG. 4 illustrates the method steps to take acoustic measurements of a subject. In step 400, an acoustic chamber is adjusted to a height suitable for the subject. The height of the acoustic chamber is adjusted relative to the height of the subject manually, or via the use of linear motors/actuators, or via the use of a platform, a chair, a stool, or the like.

In step 410, the subject is aligned relative to a reference point within the acoustic measurement chamber. The reference point is determined by the predetermined relationship according to which the acoustic measurement chamber is arranged. Optionally, the reference point is at a known location relative to a predicted sweet spot that may be generated by the loudspeakers 110 of an acoustic chamber 100. At least an aural cavity (and optionally two) is located so that it is contained within an imaginary surface that contains the multiple loudspeaker effective point sources.

The alignment step 410 may involve manual assistance and/or a self-alignment system. The self-alignment system may comprise at least one display connected to at least one video camera device. Optionally, the self-alignment system comprises at least one laser. Each laser can provide measurements of the distance of a part of the subject to the respective laser. The at least one display may display real-time video footage of the subject to the subject or to an external observer. The video camera devices and the displays may also be connected to a processing unit to provide simultaneously to the subject an overlay with real-time footage, so a subject or an external observer can more easily see the location of the head of the subject relative to the reference point. Adjusting the height of the acoustic chamber relative to the subject and aligning the subject relative to a reference point in the acoustic chamber can improve the accuracy of the acoustic measurements, and therefore the quality of the products of the audio processing of the acoustic measurements. A processing unit is a computing device capable of processing the video feeds of at least one video camera device and providing output to a display that shows real-time data to a subject or an external observer indicating a current position of the subject relative to the reference point. Optionally, a processing unit is a desktop computer, laptop computer, tablet, smartphone, server, or cloud computer. Optionally, the processing unit is capable of receiving data input, from at least one laser, that includes the distance of a part of the subject relative to the respective laser and providing output to a display responsive to the data input to aid the subject in the alignment process.

In step 420, at least one microphone element is placed on or within at least one ear or artificial ear or aural cavity of the subject.

In step 430, a first predetermined audio signal is played back through at least one of the loudspeaker elements. The predetermined audio signal may be an impulse of a particular frequency or a sinusoidal sweep of multiple frequencies that is inclusive thereof. A sinusoidal sweep of frequencies is an audio signal comprising a sinusoidal wave that progressively increases in frequency at a predetermined rate between a predetermined range of frequencies. Responsive to the predetermined audio signal and the physical characteristics of the subject, an audio signal (i.e. the HRTF associated with the first loudspeaker at given location) is captured by the at least one microphones and is recorded, in a digital data form, to a memory unit. This step is then repeated for as many impulse (or signal representative thereof) and loudspeaker element (of a particular location) combinations as desired. If the predetermined audio signal is a sinusoidal sweep of multiple frequencies, there may be a further step wherein a deconvolution technique is applied to the captured audio signal to determine an impulse-equivalent response of audio stimuli to the physical characteristics of the subject. A sinusoidal sweep may also be referred to as a sine sweep. Aptly, the deconvolution technique comprises a deconvolution step whereby the recorded signal is convolved with an inverted copy of the sine sweep in order to effectively simulate an impulsive stimuli.

As illustrated in FIG. 4 by step 440, the audio signal data can be processed to obtain HRTFs. Optionally, the digital data can be processed to obtain BiRADIAL HRTFs for one or both ears (or aural cavities) of a subject. Optionally, the digital data can be processed to obtain hybrid HRTFs. Optionally, the digital data can be processed to obtain synthesised far-field HRTFs. Optionally, the digital data can be processed to obtain a binaural Ambisonics renderer. The renderer is an element that converts from an audio file, which is encoded in a particular audio format, to a set of binaural signals suitable for a headphone setup. The Ambisonic renderer converts an Ambisonics audio file into a set of binaural signals suitable for the headphone setup. Ambisonic rendering defines a process of reproducing a soundfield from a finite number of fixed points with a particular angular resolution. Optionally, the digital data can be processed to obtain a personal digital data profile. Optionally, the digital data can be processed to obtain a subject specific digital data profile. Aptly, certain embodiments of the present invention provide an Ambisonics renderer that converts the Ambisonic audio input file to a binaural signal. Aptly, the Ambisonics renderer executes a two-step process that includes an Ambisonic decoder step, which produces loudspeaker signals, and then a renderer step, which convolves those signals with the HRTFs and sums them to produce a binaural signal. Aptly, this two-step process can be combined into a single step which is performed by the renderer directly in the Ambisonic domain.

The Ambisonic audio file provides a surround-sound format that allows for the reproduction of a soundfield via an arbitrary loudspeaker layout, so long as there are a sufficient number of loudspeakers comprising the layout and, for a given number of loudspeakers, the loudspeakers are suitably arranged so that the signals from the loudspeakers appropriately interfere at a desired listening location. Via the steps in accordance with the present invention, a soundfield is decomposed into a component form based on the special mathematical functions known as ‘spherical harmonics’. By representing a soundfield in this way, certain transformations of the soundfield, such as rotational transformations, can be computed efficiently due to the natural mathematical symmetries of spherical harmonics.

For a given order of an Ambisonic format, it is the components of the decomposed soundfield that are decoded to generate the signals that are sent each loudspeaker in a respective loudspeaker layout. The ‘order’ of an Ambisonics format is determined from the number of components into which a soundfield is decomposed.

Certain embodiments of the present invention provide a subject specific binaural Ambisonics renderer determined from near-field acoustic measurements of the subject. One advantage of the provided subject specific (e.g. a personal) Ambisonics renderer is that it provides a listener/user the benefit of lower-latency audio processing and a higher accuracy of sound localisation over conventional solutions. One area in which this is useful is when the head of the listener/user is being tracked in space and the head movements (e.g. rotational head movements) affect the sounds that the listener/user hears. This is useful in the context of professional computer gaming (which may also be referred to as ‘eSports’), for example, as a player who can more precisely and more quickly locate the source of an in-game sound has an advantage over his competitors.

FIG. 5a shows an anthropomorphic model of a human head. Conventionally, such models are used as dummy audience members at a specific recording event, such as a concert or recording studio session, and may feature a microphone and audio-specific electronics integrated into the ears and head of the model allowing direct binaural recording of audio content. Unfortunately, this means that conventionally such model may need to be present at each instance when a binaural recording is desired. In contrast with an acoustic chamber disclosed herein, it is possible to determine HTRFs of the model, which can then be applied to generic audio content to virtualise a binaural audio experience. This can allow cheaper and more convenient large-scale distribution of binaural audio content. It will be noted that the acoustic chamber as disclosed herein could be used in tandem with the audio electronics and microphone elements already included in an anthropomorphic model or dummy mannequin. For example, if an anthropomorphic model or dummy mannequin includes built-in microphones and amplifiers, these microphones and amplifiers can be used to record the signals incident proximate to an aural cavity or artificial ear of the anthropomorphic model or dummy mannequin and provide the digital data to a memory unit.

FIG. 5b shows a dummy mannequin. In addition to a head, this dummy features a torso. Optionally, the head and/or torso can be constructed from flesh imitating material. A dummy comprising a torso could be used to provide acoustic measurements that more closely resemble those of the average person (notwithstanding the other physical characteristics that affect the reflection, diffraction, and refraction of sound waves), and therefore one or more HRTFs or, an audio profile or audio renderer, determined from these acoustic measurements may be used to create a more immersive audio experience than those determined from measurements of a dummy without a torso.

FIGS. 6a, 6b, and 6c each show a respective approximate sweet spot 630 of surround sound reproduction relative to a subject 610 that is between virtual loudspeakers 620. The loudspeakers 620 in each of FIGS. 6a-6c lie on a respective imaginary circle 600. In FIG. 6a, the sweet spot 630 is a sweet spot as it may appear at the centre of the virtual loudspeakers 620. As each ear of a person samples a soundfield independently—each from a different point in space—a conventional implementation of Ambisonics may attempt to produce a sweet spot large enough to include both ears. However, to limit unwanted effects such as spatial-aliasing, rendering a sufficiently large sweet spot can require the limitation of the frequencies of sound that can be included in the soundfield or the use of high-order Ambisonics to achieve a satisfactory result.

FIG. 6b shows how time-aligned HRTFs can be used to overcome the aforementioned problem by manipulating the head-centred soundfield. In FIG. 6b, there is a soundfield that has a sweet spot 630 at the location of an ear of a subject 610. It will be understood that there is the simultaneous reproduction of the sound field at the location of the other ear. The soundfield can be manipulated by imposing a group delay on the head-centred HRTFs, producing time-aligned HRFFs, to ensure that each virtual loudspeaker feed arrives at each ear at the same time. However, by doing so the interaural time difference (ITD) is lost, affecting the sound localisation properties of the HRTFs. Therefore, hybrid HRTFs are constructed out of a combination of the head-centred HRTFs and the time-aligned HRTFs, with a crossover group delay as described in FIG. 7, to achieve a balance of reducing comb filtering and spatial aliasing and improving the accuracy of sound localisation.

In this context, the group delay of an audio signal is the time delay introduced during the reproduction of the audio signal into sound for the component frequencies of the audio signal.

FIG. 6c shows a sweet spot 630 around the left ear of a subject 610. It will be understood that there exists a separate sweet spot for the left ear. Unlike the sweet spots in FIG. 6b, the sweet spots in FIG. 6c are created by a pair of independent virtual loudspeaker arrays (i.e. two separate groups of virtual loudspeakers create the sweet spots at each ear; one group for the left ear and one group for the right). This may be referred to as ‘BiRADIAL’ Ambisonic Rendering. BiRADIAL Ambisonic Rendering can allow higher frequency reproduction at lower order Ambisonics.

FIG. 7 shows a graph of the group delay of an HRTF audio signal plotted against frequency, showing the crossover frequency for an arbitrary order of Ambisonics. For a given order of Ambisonics, a crossover frequency can be determined, which describes the transition of the use of head-centred HRTFs to time-aligned HRTFs, by assigning a group delay to the HRTF of the corresponding frequency. This is to provide a balance between providing a sufficient sweet spot in the reproduced soundfield and preserving some of the binaural audio quality for an arbitrary sound comprising numerous frequencies. A curve 710 shows a relationship between group delay and frequency for frequencies below and up to the crossover frequency 720. A curve 730 shows a relationship between group delay and frequency for frequencies in a crossover band of frequencies. A curve 740 shows a relationship between group delay and frequency for frequencies not included in the crossover band and above the crossover frequency 720. By using a curve such as 730 to describe the crossover from head-centred HRTFs to time-aligned HRTFs, the effects of comb filtering are reduced.

FIG. 8a shows the virtual loudspeakers 840 in a virtual loudspeaker array rendered using a non-BiRADIAL Ambisonic decoding technique. Each virtual loudspeaker 840 provides two channels of sound (i.e. provides stereophonic sound). A first channel from each virtual loudspeaker 840 contributes to the sweet spot at a first ear 870 of a subject 810, and a second channel from each virtual loudspeaker 840 contributes to the sweet spot at a second ear 880 of a subject 810.

FIG. 8b shows two virtual loudspeaker arrays. A first virtual loudspeaker array is comprised of virtual loudspeakers 850, and a second virtual loudspeaker array is comprised of virtual loudspeakers 860. The virtual loudspeakers arrays are rendered using a BiRADIAL Ambisonic decoding technique; therefore, each of the virtual loudspeakers 850, 860 provides one channel of sound (i.e. provides monophonic sound). The channels from the virtual loudspeakers 850 generate the sweet spot at a first ear 870 of a subject 810, and the channels from each virtual loudspeaker 860 contributes to the sweet spot at a second ear 880 of a subject 810.

FIG. 9 shows a bar graph illustrating the frequencies at which different Ambisonic and HRTF techniques can be used. Optionally, first order Ambisonics render satisfactorily soundfields comprising frequencies up to around 700 Hz. It will be understood that higher order Ambisonic rendering can be used. Optionally, head-centred HRTFs are crossed-over to Time-Aligned HRTFs for frequencies above around 1500 Hz. It will be understood that other crossover frequencies can be used. Regarding the impact on sound localisation, interaural time differences (ITDs) are shown as dominant over interaural level differences (ILDs) for frequencies below around 1500 Hz; it will be understood that this frequency is given by way of example. ILDs are shown as dominant over ITDs for frequencies above around 1500 Hz; it will be understood that this frequency is given by way of example.

In FIG. 10, there is a block diagram showing the process of creating hybrid HRTFs comprising head-centred HRTFs and time-aligned HRTFs. In step 1000, head-centred HRTFs of a specific subject are obtained, for example according to the method steps as shown in FIG. 4. In step 1010, an incremental time delay is introduced to the head-centred HRTFs for each ear, producing a set of intermediate HRTFs for each ear. The time delay may be, for example, according to the curve 730. The time delay is introduced for frequencies in the head-centred HRTF signals up to the cross over frequency 720. The time delay introduced is negligible for frequencies below the first-increment frequency 750. In general, the time delay introduced can be determined individually for each HRTF because each HRTF corresponds to a particular location relative to the subject measured. For example, the location of each ear of a subject relative to the loudspeakers.

In step 1020, a Low-Pass Filter (LPF) effect is applied to each set of intermediate HRTFs that attenuates the amplitude of frequencies in the HRTF signal above the cross over frequency, producing a first set of time-aligned HRTFs for each ear.

In step 1030, a second copy of the head-centred HRTFs are time-aligned by introducing a fixed time delay for all frequencies, producing a second set of intermediate HRTFs for each ear, where the time delay is calculated according to the location of each ear relative to the loudspeakers.

In step 1040, a High-Pass Filter (HPF) effect is applied to the intermediate HRTFs that attenuates the amplitude of frequencies in the HRTF signal below the cross over frequency, producing a second set of time-aligned HRTFs for each ear.

In step 1050, the first and second sets of time-aligned HRTFs are combined for each ear, respectively, producing what is referred to as ‘hybrid HRTFs’ for each ear. These hybrid HRTFs for each ear can also be packaged together into a single set of stereophonic hybrid HRTFs. Optionally, the first and second set of time-aligned HRTFs are combined via a linear phase crossover filter effect. It will be understood that alternative methods could be used to combine these two sets of HRTFs.

In FIG. 11, there is a block diagram showing the process of creating hybrid HRTFs comprising head-centred HRTFs and BiRADIAL HRTFs. In step 1100, head-centred HRTFs of a subject are obtained, for example according to the method steps as shown in FIG. 4.

In step 1110, an incremental time delay is introduced to the head-centred HRTFs, producing a first set of intermediate HRTFs for each ear, for example according to the curve 730, to a first copy of the head-centred HRTFs, up to the cross over frequency 720. The time delay introduced is negligible for frequencies below the first-increment frequency 750. In general, the time delay introduced can be determined individually for each HRTF because each HRTF corresponds to a particular location relative to the subject measured.

In step 1120, a Low-Pass Filter (LPF) effect is applied to the intermediate HRTFs for each ear that attenuates the amplitude of frequencies in the HRTF signal above the cross over frequency, producing a first set of time-aligned HRTFs for each ear.

In step 1130, BiRADIAL HRTFs for each ear of a subject are obtained, for example according to the method steps as shown in FIG. 4. In step 1140, a High-Pass Filter (HPF) effect is applied to the BiRADIAL HRTFs that attenuates the amplitude of frequencies in the HRTF signal below the cross over frequency, producing a set of truncated BiRADIAL HRTFs for each ear.

In step 1150, the truncated BiRADIAL HRTFs and time-aligned HRTFs are combined for each ear, respectively, producing another example of hybrid HRTFs for each ear. These hybrid HRTFs for each ear can also be packaged together to form stereophonic hybrid HRTFs. Optionally, the first and second set of time-aligned HRTFs are combined via linear phase crossover filter effect. It will be understood that alternative methods could be used to combine these two sets of HRTFs.

FIG. 12 illustrates the steps of a method to determine a synthesised far-field HRTF. In step 1200, near-field time-aligned HRTFs or near-field BiRADIAL HRTFs are obtained, for example according to the above-discussed methods.

In step 1210, the near-field time-aligned HRTFs or near-field BiRADIAL HRTFs are distance-compensated and encoded into a spherical harmonic format.

Conventionally, certain Ambisonics techniques are based on the assumption of plane wave theory, mathematically encoding a source into spherical harmonics assumes that the source has a planar wavefront. In accordance with the present invention, for acoustic measurements taken in the near-field, which thus involve sound waves having a non-planar wavefront, near-field compensation (NFC) steps are applied so the HRTFs are suitable for use in an Ambisonics renderer.

The Ambisonic components, βₘᵢ^{σ}, of a plane wave signal, s, of incidence (φ,ϑ) may be defined:

βₘᵢ^{σ}=s·Yₘᵢ^{σ}(φ,ϑ) (1)

For a (radial) point source of position (φ,ε,rₛ) it is helpful to consider the near-field effect filter, Γₘ, such that:

βₘᵢ^{σ}=S·Γₘ(rₛ)·Yₘᵢ^{σ}(φ,ϑ) (2)

Γₘ(rₛ)=k·d_{ref}·hₘ⁻(krₛ)·j^{-(m+1)} (3)

Where:

$$k = \frac{2 π f}{c} = \frac{ω}{c}$$

is the wave number;
d_{ref} is the distance at which the source, s, was measured—it is a compensation factor that derives from the equation:

$$pressure = \frac{1}{distance}$$

hₘ⁻(krₛ) are the spherical Hankel functions of the second kind (divergent);
j is the imaginary number;
Γₘ(rₛ) is the degree dependent filter that simulates to effect of a non-planar source.

Equation 2 can be simplified into the following form:

$${β}_{m i}^{σ} = s \cdot {F}_{m}^{τ} \cdot {Y}_{m i}^{σ} ( ϕ , ϑ ) \\ Where : \qquad ( 4 )$$

$${F}_{m} = \frac{{Γ}_{m}}{{Γ}_{0}} = {\sum }_{i = 0}^{m} \frac{( m + i ) !}{( m - i ) ! i !} {( - \frac{jc}{ω {r}_{s}} )}^{i} \qquad ( 5 )$$

Whereby Fₘ are the degree dependent transfer functions which model the near-field effect of a signal originating from the point (φ,ϑ,rₛ) having been measured from the origin. The filters apply a phase shift and bass-boost to sources as they approach the origin and have a greater effect on higher order components. The near-field properties of the original source and the reproduction loudspeaker are considered when applying NFC.

In step 1220, mathematical functions representing an audio impulse source are encoded into a spherical harmonic format for a set of frequencies and are convolved with the HRTFs provided via step 1210. Interaural Time Differences (ITDs) are determined for each HRIR from the position of the subject, of whom/which the acoustic measurements were taken, relative to the loudspeakers and the predetermined spatial relationship according to which the loudspeakers are arranged.

In step 1230, after introducing time delays, synthesised far-field (time-aligned or BiRADIAL) HRTFs are derived. Optionally, the synthesised far-field HRTFs are derived in a spherical harmonic format. The synthesised far-field HRTFs might also be referred to as far-field-equivalent HRTFs.

Aptly, near-field (time-aligned or BiRADIAL) HRTFs may be encoded into spherical harmonic format in the form of a binaural Ambisonic renderer and distance compensated.

Aptly, impulse input sources may also be encoded into spherical harmonic format. These may be convolved with the encoded time-aligned or BiRADIAL HRTFs (that form part of a binaural renderer) to produce synthesised far-field time-aligned or BiRADIAL HRTFs. However, time-aligned or BiRADIAL HRTFS can occasionally be limited in their use because they may not reproduce ITDs at low frequencies. Therefore, a time delay can be reintroduced at this point. This results in head-centred synthesised far-field HRTFs. These synthesised HRTFs may then be used in an Ambisonic renderer or indeed converted to hybrid HRTFs at this point for improved reproduction accuracy.

It will be understood that synthesised far-field hybrid HRTFs may be determined in accordance with the present invention. Synthesised far-field hybrid HRTFs may be determined from near-field hybrid HRTFs that may be encoded into a spherical harmonic format and distance compensated. Impulse input sources, which may also be encoded into a spherical harmonic format, may be convolved with the near-field hybrid HRTFs to produce synthesised far-field hybrid HRTFs.

FIG. 13 illustrates a method for providing a subject specific Ambisonic renderer, for example a personal Ambisonic renderer. In step 1300, acoustic measurements of a specific subject are obtained, for example according to the method as illustrated in FIG. 4.

In step 1310, near-field hybrid (BiRADIAL or time-aligned) HRTFs or synthesised far-field hybrid HRTFs are determined for the specific subject.

In step 1320, where appropriate, the HRTFs is provided via step 1310 are distance-compensated. The HRTFs are then integrated into a subject specific Ambisonics renderer. A subject specific Ambisonics renderer might also be referred to as a subject specific Ambisonics decoder or a subject specific Ambisonics profile.

In step 1330, the subject specific Ambisonics renderer is then provided to the user in an appropriate file format via an appropriate means, for example via electronic file transfer, email, cloud computer access, or providing headphones with the subject specific renderer inbuilt/on board.

In step 1340, the subject specific Ambisonics renderer can then be integrated into software, such as a music player, video player, web-browser, operating system, video game, video game engine, and the like, or (if appropriate) an application programming interface (API) thereof, executed on a computer, smart phone, cloud server, cloud server, and the like to provide a subject specific binaural audio experience for the subject.

FIG. 14 illustrates a combined workflow comprising the methods illustrated in FIGS. 10 through 13. The steps shown in FIG. 14 that terminate at step 1 show an outline of how to produce a subject specific binaural Ambisonics renderer from near-field time-aligned HRTFs and near-field hybrid (time-aligned) HRTFs, for example via a combination of steps as described in the steps illustrated in FIGS. 4, 10, and 13.

The steps shown in FIG. 14 that terminate at step 2 show an outline of how to produce a subject specific binaural Ambisonics renderer from near-field BiRADIAL HRTFs and near-field hybrid (BiRADIAL) HRTF, for example via a combination of steps as described in the steps illustrated in FIGS. 4, 11, and 13.

The steps shown in FIG. 14 that terminate at step 3a show an outline of how to produce synthesised far-field HRTFs from time-aligned near-field HRTFs, for example via a combination of steps as described in the steps illustrated in FIGS. 4 and 12.

The steps shown in FIG. 14 that terminate at step 3b show an outline of how to produce synthesised far-field HRTFs from BiRADIAL near-field HRTFs, for example via a combination of steps as described in the steps illustrated in FIGS. 4 and 12.

The steps shown in FIG. 14 that terminate at step 4a show an outline of how to produce a subject specific binaural Ambisonics renderer from near-field time-aligned HRTFs via an intermediate far-field representation method, for example via a combination of steps as described in the steps illustrated in FIGS. 4, 10, 12, and 13.

The steps shown in FIG. 14 that terminate at step 4b show an outline of how to produce a subject specific binaural Ambisonics renderer from near-field BiRADIAL HRTFs via an intermediate far-field representation method, for example via a combination of steps as described in the steps illustrated in FIGS. 4, 11, 12, and 13.

Throughout the description and claims of this specification, the words “comprise” and “contain” and variations of them mean “including but not limited to” and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of the features and/or steps are mutually exclusive. The invention is not restricted to any details of any foregoing embodiments. The invention extends to any novel one, or novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. Apparatus for providing subject specific digital audio data, comprising:
a plurality of loudspeakers, each responsive to at least one respective audio signal input and supported in a predetermined spatial relationship in which respective locations of an effective point source of each loudspeaker all lie in an imaginary surface that at least partially contains a spatial region where a subject comprising at least one aural cavity is locatable;
at least one microphone locatable on or within an aural cavity of the subject, for providing a respective subject specific audio data output responsive to at least one physical characteristic of the subject and an audio signal output from at least one of the loudspeakers; and
an audio processor configured to process the subject specific audio data output and provide subject specific digital audio data for said subject, responsive thereto,
wherein a distance between each respective location and each aural cavity is less than 1.5 meters.

2. The apparatus as claimed in claim 1,
wherein the subject specific digital audio data comprises data that represents a superposition of sound, from the plurality of effective point sources of the loudspeakers, at the aural cavity responsive to at least one physical characteristic of the subject.

3. The apparatus as claimed in claim 1,
wherein each subject specific audio data output comprises a digital or analogue representation of a physical reverberation of an active element of the respective microphone responsive to a superposition of sound, including sound from the plurality of effective point sources of the loudspeakers, at the active element.

4. The apparatus as claimed in claim 1,
wherein said a distance is selected to provide a near field sound wave provided by a superposition of sound, including sound from the plurality of effective point sources of the loudspeakers, at each aural cavity.

5. The apparatus as claimed in claim 1,
wherein each subject comprises at least one physical characteristic responsive to a shape and size of each aural cavity and/or a density, surface texture and/or layering of supporting flesh or flesh imitating material.

6. The apparatus as claimed in claim 1,
wherein the imaginary surface comprises a hemisphere or a portion of a hemisphere or a cylinder or a portion of a cylinder or a combined surface that includes a full or partial hemisphere portion and a full or partial cylindrical portion.

7. The apparatus as claimed in claim 1, wherein the subject is a person, or a dummy mannequin, or an anthropomorphic model.

8. The apparatus as claimed in claim 1, wherein a position of at least one of the plurality of loudspeakers is adjustable responsive to a determined height of the subject.

9. The apparatus as claimed in claim 1, wherein each said respective audio signal input is representative of an impulsive input and the subject specific digital audio data comprises data representative of at least one Head Related Transfer Function (HRTF).

10. The apparatus as claimed in claim 1, wherein the predetermined spatial relationship is a spatial relationship predetermined from a regular 2-dimensional shape or a regular 3-dimensional shape.

11. A method for determining subject specific digital audio data, comprising:
providing at least one respective audio signal input to each of a plurality of loudspeakers supported in a predetermined spatial relationship, in which respective locations of an effective point source of each loudspeaker all lie in an imaginary surface that at least partially contains a spatial region where at least one aural cavity of a subject is located, thereby providing a distance between each respective location and each aural cavity of less than 1.5 meters;
responsive to at least one audio signal output from at least one of the loudspeakers, via at least one microphone located at or within an aural cavity of the subject, providing respective subject specific audio data output; and
via an audio processing system, processing the subject specific audio data output, thereby providing subject specific digital audio data.

12. The method as claimed in claim 11, further comprising:
providing the subject specific digital audio data as data that represents a superposition of sound at the aural cavity responsive to at least one physical characteristic of the subject.

13. The method as claimed in claim 11, further comprising:
providing the subject specific audio data output as a digital or analogue representation of a physical reverberation of an active element of a respective microphone responsive to a superposition of sound at the active element.

14. The method as claimed in claim 11, further comprising:
locating a subject that comprises a person or a dummy mannequin or an anthropomorphic model in a spatial region that is at least partially contained by an imaginary surface in which an effective point source of each loudspeaker lies.

15. The method as claimed in claim 14, further comprising:
prior to or subsequent to locating the subject in the spatial region, adjusting a height of at least one loudspeaker with respect to a floor surface via which the subject is located.

16. The method as claimed in claim 11, further comprising:
providing at least one near field compensated (NFC) Head Related Transfer Function (HRTF) via application of a near field compensation audio processing step to the subject specific audio data output and, optionally, modifying at least one NFC HRTF and providing at least one synthesised far-field HRTF.

17. The method as claimed in claim 11, further comprising:
formatting a suitable collection of HRTFs and providing a subject specific binaural Ambisonic renderer.

18. The method as claimed in claim 11, wherein the predetermined spatial relationship is a spatial relationship predetermined from a regular 2-dimensional shape or a regular 3-dimensional shape.

19. A subject specific digital audio profile, determined from at least one analogue audio data output provided by at least one microphone located on or within at least one aural cavity of a subject, that comprises a subject specific Ambisonics renderer that modifies digital audio input data according to at least one physical characteristic of a subject and provides personalized audio data output responsive thereto, wherein:
the at least one microphone is responsive to an audio signal output of at least one of a plurality of loudspeakers that are supported in a predetermined spatial relationship in which respective locations of an effective point source of each loudspeaker all lie in an imaginary surface that at least partially contains a spatial region where a subject comprising at least one aural cavity is locatable, wherein a distance between each respective location and each aural cavity is less than 1.5 meters; and
the analogue audio data output is processed via a near-field compensation audio processing technique.

20. The subject specific digital audio profile as claimed in claim 19, wherein the subject digital audio data comprises data representative of at least one Head Related Transfer Function (HRTF).
